(19) United States
(12) Patent Application Publication
(10) Pub. No.: US 2017/0204649 A1
(43) Pub. Date: Jul. 20, 2017

(54) MOTOR VEHICLE DOOR WITH DISPLACEABLE REAR SIDE AND QUARTER WINDOWS

(71) Applicant: FORD GLOBAL TECHNOLOGIES, LLC, Dearborn, MI (US)

(72) Inventors: Donald P. Iacovoni, Plymouth, MI (US); Paul L. Heirtzler, JR., Northville, MI (US); Victor Daniel Rojas, Detroit, MI (US)

(21) Appl. No.: 14/997,860

(22) Filed: Jan. 18, 2016

(51) Int. Cl. E05F 15/689; B60J 5/04; B60J 1/00; B60J 1/17

(52) U.S. Cl. CPC E05F 15/689; B60J 1/17; B60J 5/0419; B60J 1/008; E05Y 2900/55

(57) ABSTRACT

A motor vehicle door includes a door body, a first window carried on the door body and a second window carried on the door body. A window drive system displaces the first and second windows between opened and closed positons. A window regulator system is also disclosed.

### TECHNICAL FIELD

This document relates generally to the motor vehicle field and, more particularly, to a motor vehicle door including fully opening rear side and quarter windows.

### BACKGROUND

In motor vehicle applications, there are challenges with designing movable windows or door glass to drop inside of the door structure. Often the shape of the lower door structure does not accommodate the complete lowering of a full door glass window using traditional automotive hardware systems. This is typically an issue on rear side doors, where the location of the rear wheel well might necessitate a certain shape and size of the lower door structure that is smaller than desired, or on a front door with an outside rearview mirror that is not mounted above the beltline.

In the past, this problem has generally been resolved by one of two compromises. In the first of these compromises, illustrated in FIG. 1A, the window or door glass W does not drop completely below the beltline B found on the door at the lower side of the window frame. In this situation, the vehicle occupant does not have a comfortable place to rest his arm when the window is down. Further, there is only limited room to pass items through the opening O above the window and the portion of the opening remaining covered by the window significantly limits available ventilation.

In option number two, illustrated in FIG. 1B, the size of the movable portion of the window or door glass W is reduced so that portion may be fully opened and dropped into the door panel P. Unfortunately, this compromise increases the cost and complexity of the window system due to, for example, the addition of a fixed piece of glass G and the division bar seal S or an applique that blocks a portion of the daylight opening. Further, the presence of a fixed piece of glass above the belt line of the vehicle becomes an appearance detriment to the vehicle's overall aesthetics, especially when the vehicle door is in the open position.

This document relates to a new and improved window regulator for a rear door of a motor vehicle allowing for the full lowering of both a rear side window and a rear quarter window into the door panel, while avoiding the compromises identified above.

### SUMMARY

In accordance with the purposes and benefits described herein, a motor vehicle door is provided. That motor vehicle door comprises a door body, a first window carried on the door body, a second window carried on the door body and a window drive system displacing the first window and the second window between a closed position and an opened position.

In one possible embodiment, a first window and a second window are frameless. In another possible embodiment the first window and the second window are fully concealed within the door body when in the opened position.

In one possible embodiment, the window drive system includes a single drive motor for displacing the first window and the second window between the closed position and the opened position.

In one possible embodiment, the window drive system includes a drive motor and a first guide track and follower subsystem for the first window. The first guide track and follower subsystem functions to guide the first window while the first window is being displaced by the drive motor between the closed position and the opened position. Further, the window drive system includes a second guide track follower subsystem for the second window. The second guide track and follower subsystem functions to guide the second window while the second window is displaced by the drive motor between the closed position and the opened position.

In still another possible embodiment, the window drive system includes a second drive motor and a second guide track and follower subsystem for the second window. In this embodiment, the second guide track and follower subsystem guides the second window while the second window is displaced by the second drive motor between the closed position and the opened position.

In one possible embodiment, a pivot is provided about which the second window pivots when displaced between the closed position and the opened position. That pivot may be fixed adjacent a lower front corner of the second window or a lower rear corner of the second window. Further, a linkage is provided between the second drive motor and the second window. In one possible embodiment, that linkage includes a gear drive. In another possible embodiment, that linkage includes a slider crank connected between the second drive motor and a slot carried on the second window. In yet another possible embodiment that linkage includes a flexible drive element selected from a group consisting of a cable, a belt or a chain.

In any of these embodiments, the first window may comprise a side window and the second window may comprise a quarter window that is vehicle rearward of the side window.

In accordance with yet another aspect, a window regulator system is provided for a rear door of a motor vehicle including a rear side window and an adjacent rear quarter window. That window regulator system comprises a window drive connected to the rear side window and the rear quarter window, a first guide track and follower subsystem for the rear side window and a second guide track follower subsystem for the rear quarter window. The first guide track and follower subsystem guides the rear side window while that rear side window is being displaced by the window drive between the closed position and the opened position. The second guide track and follower subsystem guides the rear quarter window while that rear quarter window is being displaced by the window drive between a closed position and an opened position.

More specifically, the window drive may include a drive motor, a first drive cable connecting the drive motor to the rear side window and a second drive cable connecting the drive motor to the rear quarter window. Further, the window drive may include a first drive drum about which the first drive cable is wound and a second drive drum about which the second drive cable is wound. The first drive drum has a first radius R₁ and the second drive drum has a second radius R₂ where R₁≠R₂.

In one possible embodiment, the second guide track and follower subsystem includes at least one fixed guide track and a first follower and a second follower that are carried on the rear quarter window. These followers slide along the at least one fixed guide track as the rear quarter window is displaced by the window drive between a closed position and an opened position.

In the following descriptions, there are shown and described several preferred embodiments of the motor vehicle door and window regulator system. As it should be realized, the motor vehicle door and window regular system are capable of other, different embodiments and their several details are capable of modification in various, obvious aspects all without departing from the door and system as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the window regulator and the window regulator system and together with the description serve to explain certain principles thereof. In the drawing figures:

FIG. 1A illustrates one type of prior art compromise made when a door panel will not accommodate fully opening a full-sized window of door glass.

FIG. 1B illustrates a second type of prior art compromise when a door panel will not accommodate fully opening a full-sized window or door glass.

FIG. 2A is a schematic block diagram illustrating a first embodiment of the window regulator system that provides a single drive motor for fully opening the rear side window and rear quarter window below the belt line of a rear door of a motor vehicle where the two windows are fully concealed when opened.

FIGS. 2B is a schematic block diagram illustrating a second embodiment of the window regulator system that provides two drive motors for fully opening the rear side window and rear quarter window below the belt line of a rear door of a motor vehicle where the two windows are fully concealed when opened.

FIGS. 3A and 3B are schematic illustrations of an alternative embodiment showing the first and second windows in the closed and opened positions. In this embodiment, the first window is translated and the second window is rotated between the closed and opened positions.

FIG. 4 is a detailed side elevational view of the quarter glass assembly including the quarter window, window bracket and seal.

FIGS. 4A-4D are detailed schematic illustrations of four different linkages that may be used to drive the second window between the closed and opened positions.

FIGS. 5A and 5B are schematic illustrations of yet another alternative embodiment wherein the quarter glass window pivots about the lower rear corner. FIG. 5A shows the window in the closed position. FIG. 5B shows the window in the open position.

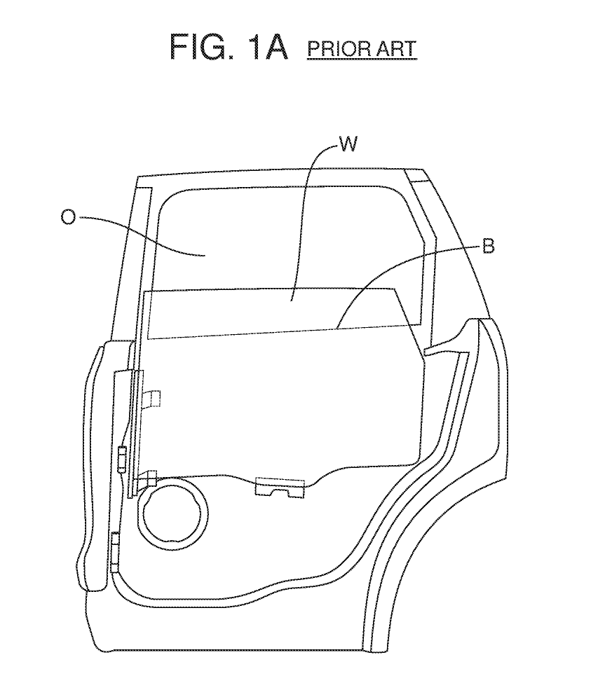

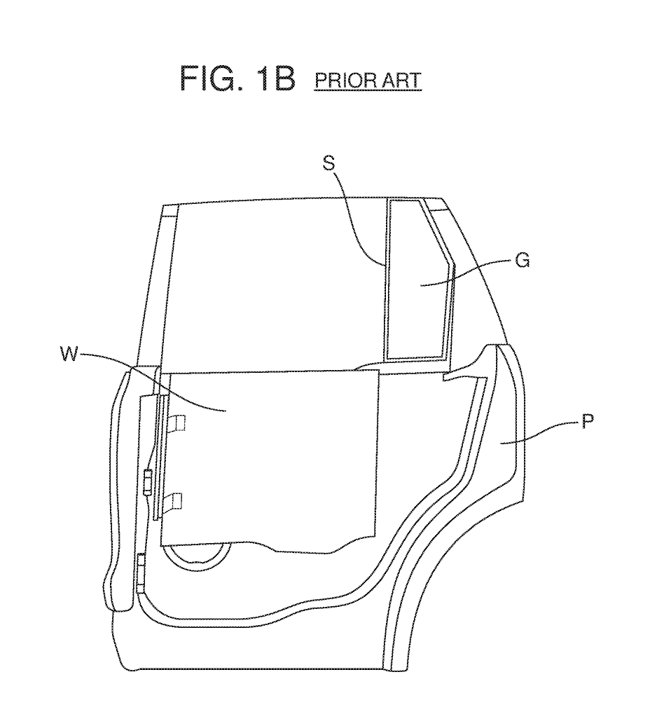

Reference will now be made in detail to the present preferred embodiments of the window regulator and window regulator system, examples of which are illustrated in the accompanying drawing figures.

### DETAILED DESCRIPTION

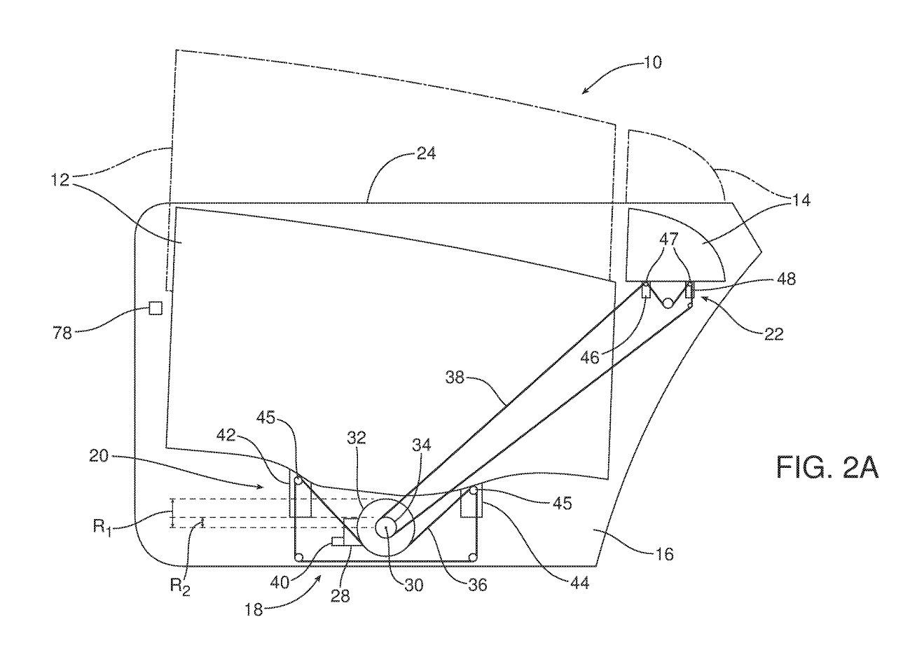

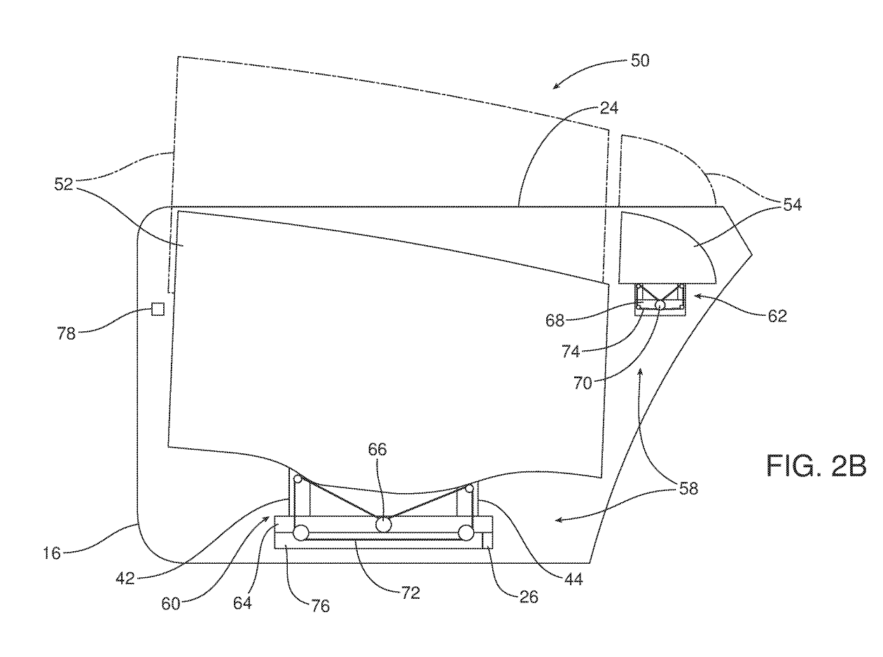

Reference is now made to FIG. 2A illustrating a window regulator system 10 for a motor vehicle including a side window 12 and an adjacent rear quarter window 14 located in a rear door 16. That window regulator system 10 further includes a window drive, generally designated by reference numeral 18. Further, the window regulator system 10 includes a first guide track and follower subsystem, generally designated by reference numeral 20 for the rear side window 12 and a second guide track follower subsystem, generally designated by reference numeral 22, for the rear quarter window 14.

More specifically, the first guide track and follower subsystem 20 and the second guide track and follower subsystem 22 each include at least one guide track. In the illustrated embodiment, the first guide track and follower subsystem 20 includes first and second guide tracks 42, 44 while the second guide track and follower subsystem 22 includes third and fourth guide tracks 46, 48. Followers 45 secured to the side window 12 slide along the guide tracks 42, 44 while followers 47 secured to the quarter window 14 slide along the guide tracks 46, 48 when the windows are displaced between the closed and opened positions. Thus the first guide track and follower subsystem 20 guides the rear side window 12 while it is being displaced by the window drive 18 between a closed position and a fully opened position concealed in the rear door 16 below the belt line 24. Similarly, the second guide track and follower subsystem 22 guides the rear quarter window 14 while that rear quarter window is being displaced by the window drive 18 between a closed position and a fully opened position where that rear quarter window is fully concealed within the rear door 16 below the belt line 24. Thus, it should be appreciated that the window regulator system 10 allows an operator to fully open the window opening above the rear door 16 by allowing both a rear side window 12 and rear quarter window 14 to be fully opened and dropped inside the rear door 16.

In the embodiment illustrated in FIG. 2A, the window drive 18 comprises a single drive motor 28 having a drive shaft 30 that simultaneously drives a first drum 32 and a second drum 34.

The window drive 18 further includes a first cable 36 that is wound on the first drum 32 and connects the drive motor to the rear side window 12 at the followers 45. In addition, the window drive 18 includes a second cable 38 that is wound on the second drum 34 and connects the drive motor 28 to the rear quarter window 14 at the followers 47. As further illustrated in FIG. 2A, the first drum 32 has a first radius R₁ while the second drum 34 has a second radius R₂ where R₁≠R₂. Thus, it should be appreciated that the drive motor 28 drives the cables 36, 38 and, therefore, the windows 12, 14 at different speeds as they are raised and lowered between the fully closed and fully opened positions depending upon the ratio of the first radius R₁ to the second radius R₂.

More specifically, in the illustrated embodiment, the first radius R₁ is greater than the second radius R₂. The drive motor 28, under control of the controller 40, drives the first and second drums 32, 34 through the drive shaft 30 so that each drum rotates 360 degrees simultaneously. Since the first drum 32 has a larger radius R₁, the first cable 36 wound on the first drum moves at a first speed S₁ that is not equal to, and in the illustrated embodiment is greater than, the speed S₂ of the second cable 38 on the second drum 34. As a result, the rear side window 12 connected to the first cable 36 is displaced with respect to the rear door 16 at a first speed S₃ greater than the rear quarter window 14 that is connected to the second cable 30 and which moves as a speed S₄. As a consequence, the two windows 12, 14 may be moved different distances in the same operating time so they both are fully displaced to a fully opened position, below the belt line 24 where they are concealed within the rear door 16 to fully open the window opening 26. Thus, both windows 12, 14 may be properly opened and closed while being driven by a single motor 28.

Reference is now made to FIG. 2B illustrating an alternative embodiment of window regulator system 50 for controlling the operation of the rear side window 52 and rear quarter window 54 in a rear door 56 of a motor vehicle. That window regulator system 50 includes a window drive, generally designated by reference numeral 58 that is connected to the rear side window 52 and rear quarter window 54. Further, the window regulator system 50 includes a first guide track and follower subsystem 60 for the rear side window 52 whereby the rear side window is guided while being displaced by the window drive 58 between a closed position and an opened position. Further, the window regulator system 50 includes a second guide track and follower subsystem 62 for the rear quarter window 54 whereby the rear quarter window is guided while being displaced by the window drive 58 between a closed position and an opened position.

More specifically, the window drive 58 in this embodiment includes a first drive motor 64 driving a first drum 66 and a second drive motor 68 driving a second drum 70. A first cable 72, wound on the first drum 66, connects the first drive motor 64 to the rear side window 52. A second cable 74, wound on the second drum, 70, connects the second drive motor 68 to the rear quarter window 54.

In this embodiment, the first and second drums 66, 70 may or may not have different radii. Instead, the speed of the cables 72, 74 and, thus, the opening and closing speed of the windows 52, 54 may be determined by the drive speed of the first and second drive motors 64, 68 under the control of the controller 76.

As should be appreciated, the controller 40, 76 in either embodiment illustrated in FIGS. 2A and 2B may comprise a dedicated microprocessor or electronic control unit (ECU) operating in accordance with instructions from appropriate control software. Thus, the controller 40, 76 is configured to control the operating speed of the windows 12, 14 or 52, 54. The controller 40, 76 may include one or more processors, one or more memories, one or more network interfaces that all communicate with each other over a communication bus in a manner known in the art. A single actuator 78, such as a toggle switch, may be provided on door 16. The operator may manipulate the actuator 78 to activate the controller 40, 76 and open or close both windows 12, 14 or 52, 54.

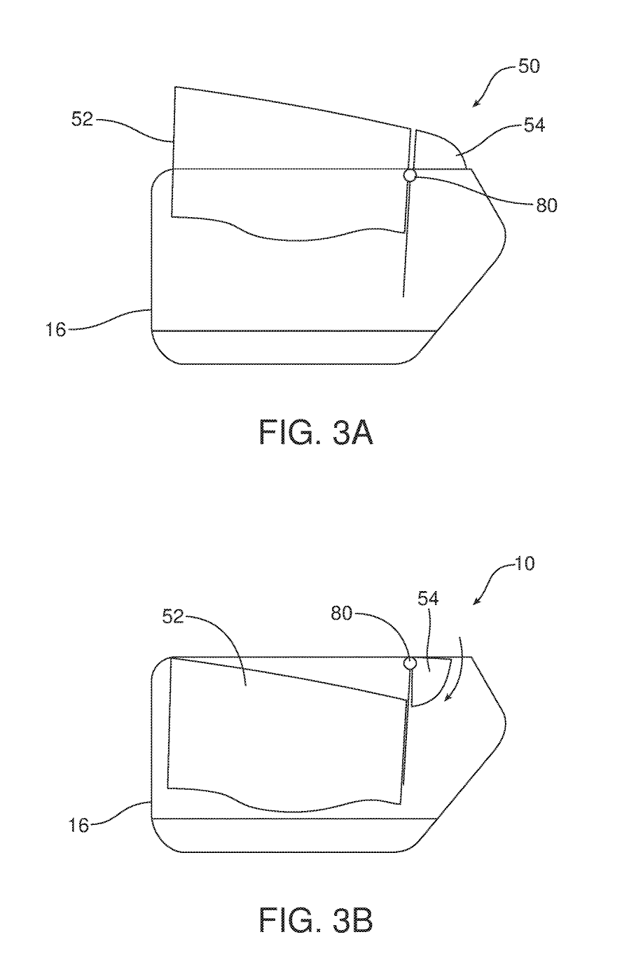

Reference is now made to FIGS. 3A and 3B which illustrate an alternative embodiment of motor vehicle door 10 wherein the first window 52 is translated between the opened and closed positions just as provided for in the embodiment illustrated in FIG. 2B but the second window 54 is rotated between the open and closed positions about a pivot 80 when displaced between the opened and closed positions rather than translated. That pivot 80 may be fixed if desired.

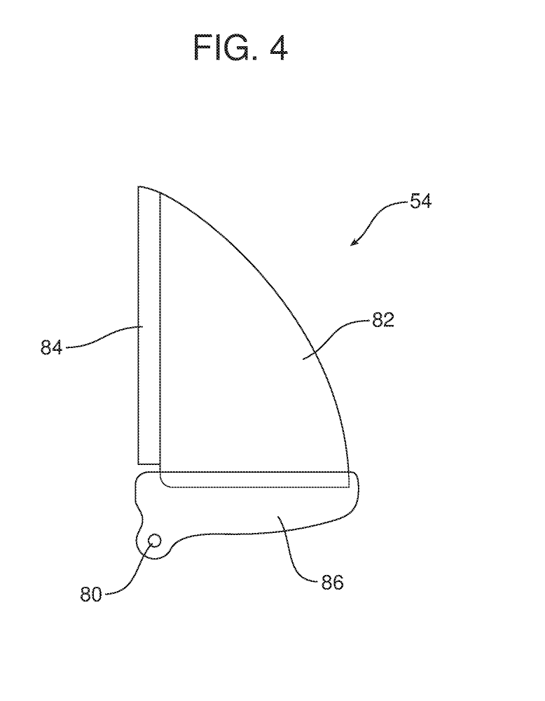

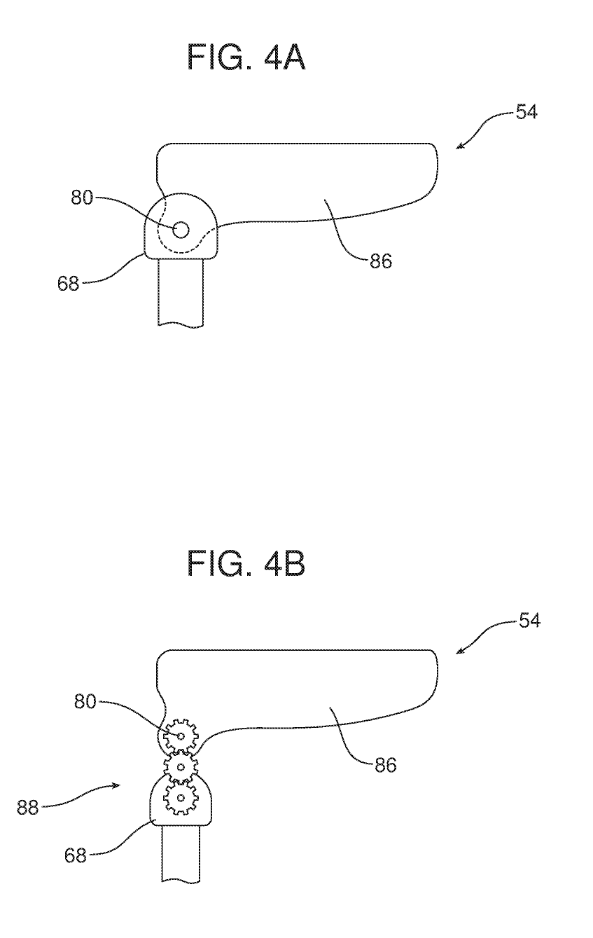

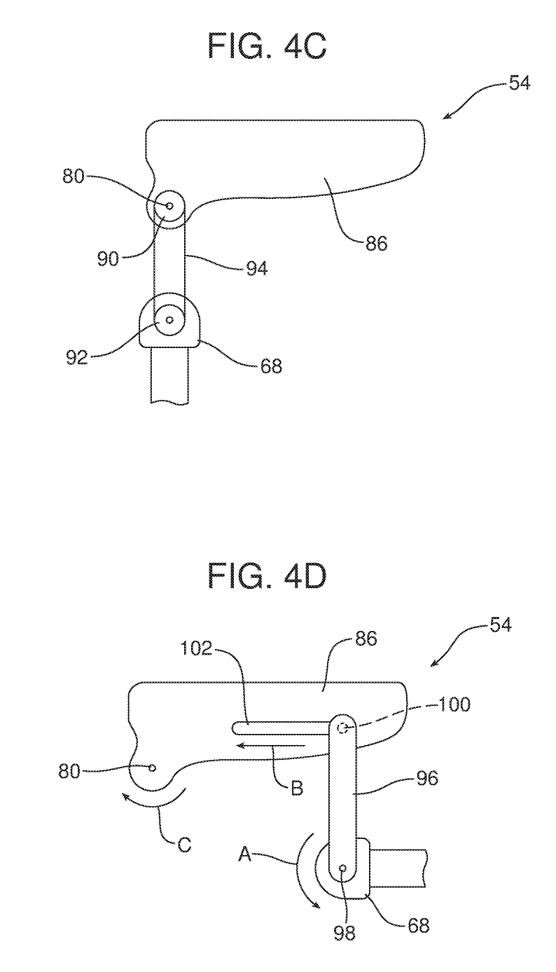

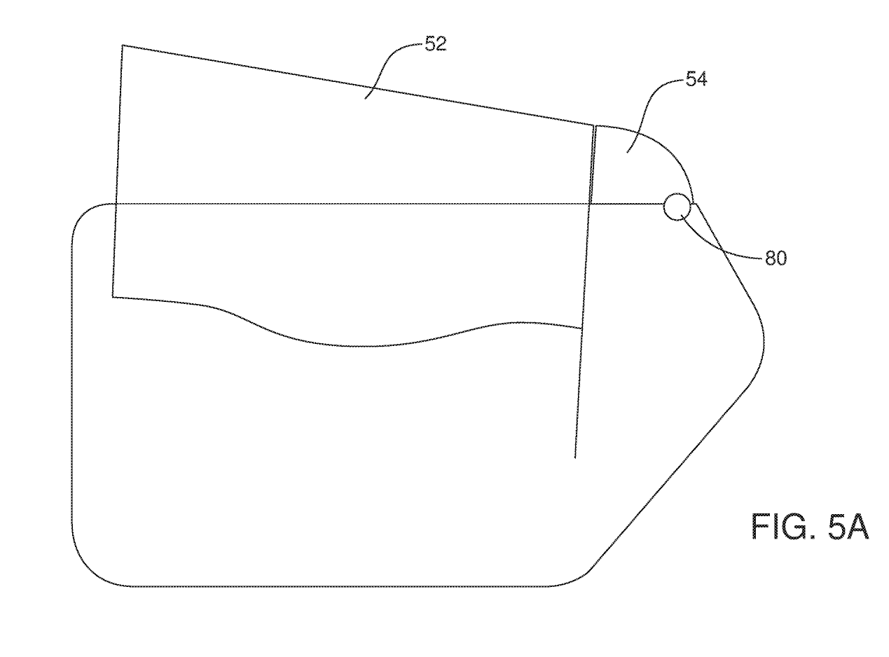

As illustrated in FIG. 4, the second window 54 comprises an assembly including (a) a quarter glass 82, (b) a seal 84 that seals the quarter glass with the first window 12 when the two windows are in the closed position, and (c) a window bracket 86 that is connected to the quarter glass and pivots about the pivot pin 80 that is fixed on the door body 16.

Reference is now made to FIGS. 4A-4D illustrating four different drive systems for rotating the second window 54 between the closed and opened positions illustrated, respectively, in FIGS. 3A and 3B. In the embodiment illustrated in FIG. 4A, the drive motor 68 is directly connected to the pivot pin 80 and the window bracket 86 is keyed to that pin so that the drive motor directly drives the second window 54 between the opened and closed positions.

In the embodiment illustrated in FIG. 4B, the drive motor 68 is connected to a gear drive, generally designated by reference numeral 88, by which the drive motor rotates the pivot pin 80. Once again, the window bracket 86 is keyed to that pin 80 so that the window 54 is pivoted between the closed and opened positions.

In the embodiment illustrated in FIG. 4C, the drive motor 68 is connected to the pivot pin 80 by means of the two pulleys 90, 92 and the drive cable, belt or chain 94. As a result, the motor 68 rotates the pivot pin 80 and the second window 54 keyed thereto to thereby displace the window between the opened and closed positions.

In yet another alternative embodiment illustrated in FIG. 4D, the motor 68 is connected by means of the slider crank 96 to the window bracket 86. More specifically, the drive shaft 98 of the drive motor 68 is keyed to the slider crank 96. The opposite end of the slider crank 96 includes a lug 100 that slides along an elongated slot 102 in the bracket 86. When the drive motor 68 pivots the slider crank 96 in the direction of action arrow A, the lug 100 slides along the slot 102 in the direction of action arrow B and the glass window bracket 86 is pivoted about the pivot pin 80 in the direction of action arrow C causing the second window 54 to be displaced from the closed position illustrated in FIG. 3A to the open position illustrated in FIG. 3B. When the drive motor 68 is driven in the opposite direction, the second window 54 is displaced from the opened position to the closed position in the opposite manner.

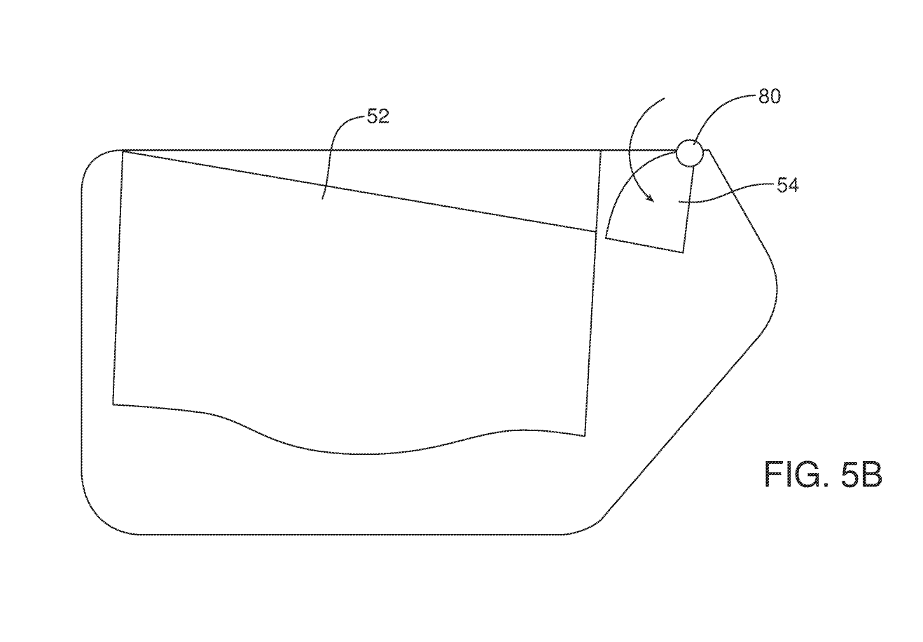

Reference is now made to FIGS. 5A and 5B illustrating yet another alternative embodiment. In this embodiment the pivot 80 for the quarter window 54 is provided adjacent the lower rear corner rather than the lower front corner as in the embodiment illustrated in FIGS. 3A and 3B. The quarter window 54 may be pivoted about the pivot 80 using any of the drive systems illustrated in FIGS. 4A-4D. If necessary for clearance purposes, the quarter window 54 may not be opened until after the side window 52 has been fully opened.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A motor vehicle door, comprising:
a door body;
a first window carried on said door body;
a second window carried on said door body; and
a window drive system displacing said first window and said second window between a closed positon and an opened position.

2. The motor vehicle door of claim 1 wherein said first window and said second window are frameless.

3. The motor vehicle door of claim 1, wherein said first window and said second window are fully concealed within said door body when in said opened position.

4. The motor vehicle door of claim 1, wherein said window drive system includes a single drive motor for displacing said first window and said second window between said closed position and said opened position.

5. The motor vehicle door of claim 1, wherein said window drive system includes a drive motor and a first guide track and follower subsystem for said first window, said first guide track and follower subsystem guiding said first window while said first window is being displaced by said drive motor between said closed position and said opened position.

6. The motor vehicle door of claim 5, wherein said window drive system includes a second guide track and follower subsystem for said second window, said second guide track and follower subsystem guiding said second window while said second window is displaced by said drive motor between said closed position and said opened position.

7. The motor vehicle door of claim 5, wherein said window drive system includes a second drive motor and a second guide track and follower subsystem for said second window, said second guide track and follower subsystem guiding said second window while said second window is displaced by said second drive motor between said closed position and said opened position.

8. The motor vehicle door of claim 5, wherein said window drive system includes a second drive motor displacing said second window between said closed position and said opened position.

9. The motor vehicle door of claim 8, further including a fixed pivot about which said second window pivots when displaced between said closed position and said opened position.

10. The motor vehicle door of claim 9, further including a linkage between said second drive motor and said second window.

11. The motor vehicle door of claim 10, wherein said linkage includes a gear drive.

12. The motor vehicle door of claim 10, wherein said linkage includes a slider crank connected between said second drive motor and a slot carried on said second window.

13. The motor vehicle door of claim 10, wherein said linkage includes a flexible drive element selected from a group consisting of a cable, a belt or a chain.

14. The motor vehicle door of claim 1, wherein said first window is a side window and said second window is a quarter window vehicle rearward of said side window.

15. A window regulator system for a rear door of a motor vehicle including a rear side window and an adjacent rear quarter window, comprising:
a window drive connected to said rear side window and said rear quarter window;
a first guide track and follower subsystem for said rear side window whereby said rear side window is guided while being displaced by said window drive between a closed position and an opened position; and
a second guide track and follower subsystem for said rear quarter window whereby said rear quarter window is guided while being displaced by said window drive between a closed position and an opened position.

16. The window regulator system of claim 15 wherein said window drive includes a drive motor, a first drive cable connecting said drive motor to said rear side window and a second drive cable connecting said drive motor to said rear quarter window.

17. The window regulator system of claim 16, wherein said window drive further includes a first drive drum about which said first drive cable is wound and a second drive drum about which said second drive cable is wound.

18. The window regulator system of claim 17, wherein said first drive drum has a first radius R₁ and said second drive drum has a second radius R₂ where R₁≠R₂.

19. The window regulator system of claim 15, wherein said second guide track and follower subsystem includes at least one fixed guide track; and
a first follower and a second follower that are carried on said rear quarter window and slide along said at least one fixed guide track as said rear quarter window is displaced by said window drive between a closed position and an open position.

20. The window regulator system of claim 19, wherein said at least one fixed guide track comprises a single fixed guide track and said first follower and said second follower both slide along said single fixed guide track.
